(19) United States
(12) Patent Application Publication
(10) Pub. No.: US 2009/0314160 A1
(43) Pub. Date: Dec. 24, 2009

(54) METHOD AND APPARATUS FOR REGENERATING A SORPTION DRYER OR CLEANER

(76) Inventor: Willem Meijer, Zelhem (NL)

Correspondence Address: JENSEN + PUNTIGAM, P.S., 2033 6th Ave, Suite 1020, SEATTLE, WA, 98121, US

(21) Appl. No.: 12/089,687

(22) PCT Filed: Oct. 9, 2006
(86) PCT No.: PCT/NL06/00508

§ 371 Date: Jul. 14, 2008

(30) Foreign Application Priority Data
Oct. 10, 2005 (NL) 1030149

(51) Int. Cl. B01D 53/04

(52) U.S. Cl. 95/148

(57) ABSTRACT

An apparatus and method for regenerating a sorption dryer or cleaner by periodically heating the sorbing surface utilizing a number of heating elements distributed along the sorbing surface which are alternately switched on and off.

### TECHNICAL FIELD

This invention relates to the method and apparatus for regenerating a sorption dryer or cleaner, and more particularly to sequentially applying heat to a portion of the sorption surface to separate the substances.

### BACKGROUND OF THE INVENTION

Sorption dryers or cleaners are used to dry or to clean media, in particular gases, by means of absorbing or adsorbing respectively moisture present therein or contaminants present therein. Absorption is when the material which extracts the moisture from the medium thereby undergoes a physical or chemical change, for instance is absorbed into the moisture. Adsorption is when the extracted moisture is merely held fast on or in the surface of the material. Both these phenomena are summarized below using the terms “sorption” or “sorbing”. Applications of this principle are for instance drying of ambient air by sorbing water present therein, such as takes place for instance in climate control. Another example is cleaning of a gas such as methane transported through a pipe system, by sorbing methane hydrides present therein.

Drying or cleaning of gas flows in this way is in fact a two-stage process. In a first process step the undesirable substances, thus the moisture or the contaminants, are sorbed from the gas flow for drying or cleaning by leading the gas along a material which has a greater affinity for these substances, or has a lower vapour pressure than the gas itself. In a second stage of the process the sorbed substances are then once again relinquished to another medium, for instance a gas flow to be discharged. In order to release the substances from the sorbing material the temperature must generally be increased considerably in order to increase the vapour pressure thereof to a level above that of the gas flow to be discharged.

In the example of drying air in climate control, moisture is thus extracted from air which is drawn in from outside, and this moisture is relinquished again to air which is extracted from the building and once again blown to the outside. In order to extract water from the outside air the air is guided along surfaces which are covered with a layer of strongly water-adsorbing material, such as silica gel. In order to then relinquish the water, air, for instance (a part of) the discharge air, is heated to above the boiling point of water and guided along the adsorbent material, whereafter the water vapour can escape therefrom and is entrained in the outgoing airflow. The adsorbent material is hereby regenerated and is once again able to extract large quantities of water from the air.

In practice use is usually made here of a rotating wheel with a number of surfaces which extend in radial direction and which are covered with the adsorbent material. This wheel is placed between a feed duct and a discharge duct with its rotation shaft parallel to the direction of flow of the air in the ducts such that the covered surfaces move through the feed duct during part of a rotation and through the discharge duct for the remaining part of the rotation. During the passage through the feed duct the covered surfaces extract water from the indrawn air, and during the passage through the discharge duct this water is once again relinquished. In order to release as much water as possible from the adsorbent serial in the short time that the surfaces move through the discharge duct, the wheel must be heated far above the boiling point of water, for instance up to 180° C. This requires a great deal of energy; not only to heat the water to the boiling point and beyond, but particularly to evaporate the water, since the evaporation heat of water is much greater than the specific heat thereof.

In order to drastically reduce the energy consumption of sorption dryers and cleaners it has already been proposed in the non-prepublished Netherlands patent application 1029822 to use a so-called LCST (Lower Critical Solution Temperature) polymer. An LCST polymer is a polymer which is soluble in the substances to be separated up to a determined temperature, the critical solution temperature or the transition point, but which is no longer soluble above this critical solution temperature, so that the absorbed substances are in fact repelled. The stability of the polymer in dissolved state is ensured here by suitably chosen cross-linkers. The transition point is clearly below the boiling point of the substances to be separated. Because the transition point of an LCST polymer is so low, for instance in the order of 60-70° C., the polymer requires far less heating than is necessary in the case of usual sorbing materials such as silica gel. Furthermore, the sorbed substance does not have to be evaporated in order to be released from the LCST polymer, whereby the evaporation heat, which requires by far the most energy, is saved.

### DISCLOSURE OF THE INVENTION

The present invention now has for its object to provide a method for regenerating a sorption dryer or cleaner which is simpler to perform and requires less energy than the above described conventional regeneration method. The invention also has for its object to provide an apparatus for regenerating a sorption dryer or cleaner which is structurally simpler and cheaper and has a lower energy consumption than the conventional regenerating apparatus. In respect of the method this is achieved by the combination of measures as described in claim 1. A regenerating apparatus according to the invention is characterized by the measures as stated in claim 6.

Making use of the fact that when a polymer with low critical solution temperature is used, considerably less heat need be supplied in order to once again release the sorbed substances, the invention is based on the insight that the necessity for complicated moving constructions is thereby dispensed with, and the regeneration step can be performed at the same location as—and if desired even simultaneously with—the sorption step. The surface with the sorption material for regeneration can thus be held stationary and periodically exposed to the action of heating means.

An active part of the heating means can herein displace along the surface so that a different portion of the surface at a time is regenerated. When the regeneration takes place during normal operation of the sorption dryer or cleaner, substances for separating are extracted from the passing gas, flow over the greater part of the surface, while substances are being relinquished from the surface, again over a small fraction thereof. A small part of the substances is once again entrained into the gas flow, while the greater part will flow away along the surface to a collecting space. While it is true that the total efficiency of the sorption dryer or cleaner hereby decreases slightly, this is more than compensated by the considerable simplification of the construction—and thereby reduction in costs—hereby achieved.

Preferably applied variants of the method according to the invention are described in the dependent claims 2-5, while preferred embodiments of the regenerating apparatus form the subject-matter of dependent claims 7-12.

### BRIEF DESCRIPTION OF THE DRAWINGS

The invention is now elucidated on the basis of an embodiment, wherein reference is made to the accompanying drawing, in which:

FIG. 1 is a perspective detail view with exploded parts showing the structure of a sorption dryer or cleaner provided with a regenerating apparatus according to the invention,

FIG. 2 is a schematic perspective view of the sorption dryer or cleaner with regenerating apparatus of FIG. 1 during the regeneration of a first part of the dryer or cleaner, and

FIG. 3 is a view corresponding to FIG. 2 of the sorption dryer or cleaner during the regeneration of another part thereof.

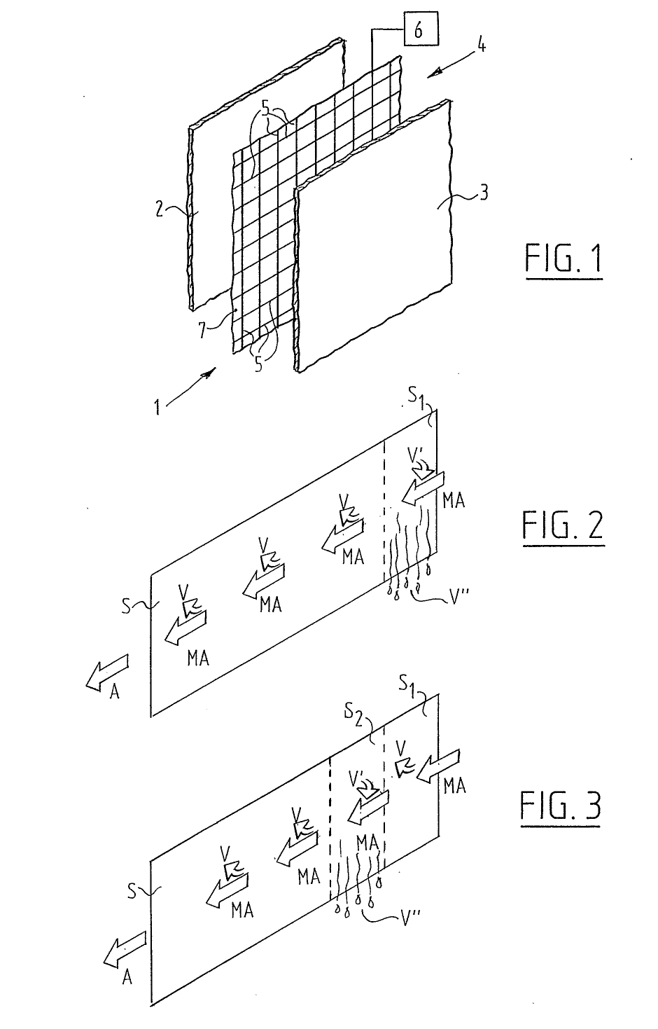

### BEST MODE FOR CARRYING OUT THE INVENTION

A sorption dryer or cleaner 1 is formed by a plate-like substrate 2 on which a layer of (ab or ad) sorbent material 3 is arranged. Plate-like substrate 2 herein defines a surface S, for instance the wall of a duct for supplying air to a space. The sorbent material 3 is a low critical solution temperature polymer, for instance polyoxazoline, poly (dimethylamino ethyl methacrylate) (pDMAEMa) or poly (N-isopropylacrylamide) (pNiPAAm). It is otherwise also possible to envisage the LCST polymer being self-supporting, thereby dispensing with the necessity of a separate substrate.

In order to heat the polymer to its critical solution temperature, the sorption dryer or cleaner 1 is further provided with heating means 4. These take the form here of a number of heating elements, for instance heating wires 5, connected in a network. Heating means 4 further comprise a control 6, wherein a different part of the network at a time is switched on. Different parts of heating means 4 in this way become periodically active, whereby the active part of heating means 4 as it were displaces along surface S.

Heating means 4 are arranged on a carrier 7 which is mounted on substrate 2. In the shown embodiment carrier 7 even takes the form of a foil onto which the heating elements 5 and control 6 are printed and which is glued between substrate 2 and the layer of sorption material 3. A very compact construction is hereby obtained. This is possible because heating wires 5 need only supply low power since the adsorbent material 3 is after all an LCST polymer.

During use of the sorption dryer or cleaner 1 moist air MA, for instance ambient air, is blown or drawn through a duct by means of a fan, each wall of this duct being formed by a substrate 2 having thereon a layer of sorption material 3. As the moist airflow MA passes by, moisture M is extracted therefrom by sorption material 3 and then held fast. The airflow A dried in this manner leaves the duct and can be further processed, for instance cooled, before being supplied to a space.

When sorption material 3 has taken up so much moisture that it is in danger of becoming saturated, it must be regenerated by once again relinquishing the moisture. For this purpose the sorption material is heated to above a critical solution temperature at which the polymer comes out of solution and the moisture is repelled. When low critical temperature polymers (LCST polymer) are used as sorption material, this transition point will occur at a temperature clearly lower than the boiling point of water, for instance at around 60 to 70° C.

Heating means 4 according to the invention are adapted to heat one part of sorption material 3 at a time above the critical solution temperature, while the rest of the material is kept below this temperature and thus retains its normal sorbing action. Under the influence of control 6 a section S₁ of surface S close to the inflow side of the duct is for instance first heated and regenerated. A small quantity of moisture V is then relinquished here to the passing moist airflow MA which subsequently, when passing along the remaining part of surface S, relinquishes its moisture to sorption material 3 and, thus dried, leaves the duct. The greater part of the moisture V″ relinquished by the heated section S₁ otherwise flows downward along surface S and is then collected somewhere.

Control 6 then switches on another part of the network of heating wires 5 and a subsequent section S₂ is heated and regenerated. The moist airflow MA is thus then first dried as it passes the first section S₁, then takes up some moisture V from sorption material 3 in the second section S₂ and is subsequently further dried again by the remaining surface S. Here too the greater part of the repelled moisture V″ again flows away downward along surface S.

The whole surface can thus be regenerated in a short period of time by successively switching parts of the network on and off.

Although the invention is elucidated above on the basis of an embodiment, it will be apparent that it is not limited thereto and can be varied in many ways within the scope of the now following claims.

What is claimed is:

1. A method for regenerating a sorption dryer or cleaner (1) having at least one sorbing surface (S) by periodically heating the sorbing surface (S) to a temperature at which sorbed substances are separated therefrom, wherein the surface (S) is held stationary and periodically exposed to the action of heating means (4), characterized in that the heating means (4) comprises a number of heating elements (5) distributed along the surface (S), the surface (S) being periodically exposed to the action of the heating means (4) by alternately switching the heating elements (5) on and off so as to displace at least an active part of the heating means (4) along the surface (S).

2. A method as claimed in claim 1, characterized in that different parts of the surface (S) are heated successively.

3. A method as claimed in claim 1, characterized in that during the regeneration of a part of the sorption dryer or cleaner (1) the remaining part of the sorption dryer or cleaner (1) continues to operate normally.

4. A method as claimed in claim 1, characterized in that the surface (S) is heated to a temperature which is lower than a boiling point of the substances to be separated therefrom.

5. Apparatus for regenerating a sorption dryer or cleaner (1) having at least one sorbing surface (S), comprising means (4) for periodically heating the surface (S) to a temperature at which sorbed substances are separated therefrom, wherein the surface (S) is stationary and the heating means (4) are adapted to periodically expose the surface (S) to their action, characterized in that the heating means (4) comprise at least one active part displaceable along the surface, the heating means (4) comprising a number of heating elements (5) distributed along the surface (5), in addition to a control (6) for alternately switching the heating elements (5) on and off.

6. Regenerating apparatus as claimed in claim 5, characterized in that the heating means (4) are adapted to successively heat different parts of the surface (5).

7. Regenerating apparatus as claimed in claim 5, characterized in that the heating elements (5) are heating wires connected in a network.

8. Regenerating apparatus as claimed in claim 7, characterized in that the heating elements (5) and the control (6) are accommodated in a carrier (7) to be connected to the surface (5).

9. Regenerating apparatus as claimed in claim 5, characterized in that the heating means (4) are adapted to heat the surface (5) to a temperature which is lower than a boiling point of the substances to be separated therefrom.
